(19) United States
(12) Patent Application Publication
(10) Pub. No.: US 2015/0177840 A1
(43) Pub. Date: Jun. 25, 2015

(54) APPARATUS AND ASSOCIATED METHODS FOR USER INPUT

(71) Applicant: Nokia Corporation, Espoo (FI)

(72) Inventors: Esa Kankaanpaa, Hyvinkaa (FI); Shahil Soni, Espoo (FI)

(73) Assignee: Nokia Corporation, Espoo (FI)

(21) Appl. No.: 14/133,871

(22) Filed: Dec. 19, 2013

(51) Int. Cl. G06F 3/01

(52) U.S. Cl. CPC G06F 3/017

(57) ABSTRACT

An apparatus comprising: a processor; and a memory including computer program code, the memory and the computer program code configured, with the processor, to cause the apparatus to perform at least the following: based on a detected sprinkle gesture user input, provide signalling to apply an output effect using a user interface of an electronic device.

### TECHNICAL FIELD

The present disclosure relates to user interfaces, associated methods, computer programs and apparatus. Certain disclosed examples may relate to portable electronic devices, for example so-called hand-portable electronic devices which may be hand-held in use (although they may be placed in a cradle in use). Such hand-portable electronic devices include so-called Personal Digital Assistants (PDAs), mobile telephones, smartphones and other smart devices such as smartwatches, and tablet PCs.

The portable electronic devices/apparatus according to one or more disclosed examples may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

An electronic device may have a user interface which allows a user to interact with the device. For example, a device may comprise a touch-sensitive display which a user can touch to provide inputs to the device.

The listing or discussion of a prior-published document or any background in this specification should not necessarily be taken as an acknowledgement that the document or background is part of the state of the art or is common general knowledge. One or more examples of the present disclosure may or may not address one or more of the background issues.

### SUMMARY

In a first example there is provided an apparatus comprising at least one processor and at least one memory including computer program code, the at least one memory and the computer program code configured to, with the at least one processor, cause the apparatus to perform at least the following: based on a detected sprinkle gesture user input, provide signalling to apply a visual effect to displayed content on a display of an electronic device.

The shape of the user's hand or hands used to make the sprinkle gesture is detected and recognised as a sprinkle-type gesture for making a sprinkle-type user input to the electronic device. This may be done by the apparatus or be done by a different apparatus. A user may make a sprinkle gesture as they would in the real world if, for example, sprinkling grains of salt. This gesture is recognised and used by the apparatus to provide signalling to apply a visual effect to content displayed on a display of an electronic device. The user advantageously may make intuitive sprinkle gestures to interact with the device.

The sprinkle gesture user input may be one of a single-handed gesture input and a two-handed gesture input.

The sprinkle gesture user input may be one of a single-handed gesture input and a two-handed gesture input substantially above a user interface configured to detect the sprinkle gesture input and the relative spatial location of the applied visual effect may be substantially aligned with the relative spatial location of the detected sprinkle gesture on the user interface. This may advantageously add to the real-world feel of the sprinkle gesture user input. In the real world, if a user sprinkled grains onto a surface, the grains would land on the surface directly underneath the location of the user's fingers/hands.

The sprinkle gesture user input may be a single-handed gesture input comprising rubbing together of the thumb of the hand with one or more other digits of the hand.

The sprinkle gesture user input may be a single-handed gesture input comprising rubbing together of the thumb of the hand with one or more other digits of the hand substantially above a user interface configured to detect the sprinkle gesture input.

The sprinkle gesture user input may be a single-handed gesture input comprising rubbing together of the thumb of the hand with one or more other digits of the hand substantially above a user interface configured to detect the sprinkle gesture input and the relative spatial location of the applied visual effect may be substantially aligned with the relative spatial location of the detected sprinkle gesture on the user interface.

The sprinkle gesture user input may be a single-handed gesture input comprising shaking of one or more of: a substantially flat open hand; and a partially closed cupped hand.

The sprinkle gesture user input may be a two-handed gesture input comprising rubbing together of one or more of the digits and palms from the respective two hands.

The sprinkle gesture user input may be a two-handed gesture input comprising rubbing together of one or more of the digits and palms from the respective two hands substantially above a user interface configured to detect the sprinkle gesture input.

The sprinkle gesture user input may be a two-handed gesture input comprising rubbing together of one or more of the digits and palms from the respective two hands substantially above a user interface configured to detect the sprinkle gesture input and the relative spatial location of the applied visual effect may be substantially aligned with the relative spatial location of the detected sprinkle gesture on the user interface.

The apparatus may be configured to increase the speed of application of the visual effect based on an increased speed of the detected sprinkle gesture.

The apparatus may be configured to apply a differential visual effect according to the detected sprinkle gesture. Thus a particular single-handed sprinkle gesture may apply one type of visual effect, and a different single-handed sprinkle gesture or a particular two-handed sprinkle gesture may apply a different visual effect.

The apparatus may be configured to apply the visual effect incrementally according to the duration of the sprinkle gesture input.

The visual effect may be a granular application of the visual effect on a particular spatial region of the displayed content corresponding to the relative spatial location of detected sprinkle gesture.

The visual effect may be a granular application of the visual effect, and the apparatus may be configured to, as the separation between the detected user input and a user interface configured to detect the user input increases, one or more of:

the separation of grains in the visual effect increases (or decreases);

the size of grains in the visual effect increases (or decreases);

an audio signal accompanying the application of the granular application of the visual effect increases (or decreases) in volume (or vice versa with respect to decreasing separation and/or size).

The apparatus may be configured to, based on a particular distance separation from a user interface configured to detect the sprinkle gesture user input, apply one or more of a bounce and scatter visual effect, and a splat visual effect.

The apparatus may be configured to provide signalling to apply the visual effect preferentially to particular marked regions of the displayed content.

The visual effect may be one or more of: a change of colour, application of a visual highlight, and application of a glowing, glistening, reflective, or shiny granular effect.

The apparatus may be configured to apply a uniform visual effect on a particular spatial region of the displayed content corresponding to the relative spatial location of detected sprinkle gesture.

The apparatus may be configured to apply the visual effect over an increasing area across the displayed content according to one or more of the direction of, and an increasing degree of tilt of, one or more of: a user interface used to detect the sprinkle gesture input, and the display of the electronic device which is displaying content. This may advantageously add to the real-world feel of the sprinkle gesture user input. In the real world, tilting a surface onto which grains are sprinkled may result in the grains rolling/sliding down the sloping surface.

The apparatus may be configured to one or more of remove or progressively remove the applied visual effect after a predefined tilt threshold of a user interface used to detect the sprinkle gesture input is achieved. This may advantageously add to the real-world feel of the sprinkle gesture user input, because tilting a surface with grains on it past a critical angle would result in the grains sliding down and off the sloping surface.

The apparatus may be configured to one or more of detect the sprinkle gesture input itself or receive an indication of the detected sprinkle gesture input from another apparatus which detected the sprinkle gesture input.

A user interface may be configured to detect the sprinkle gesture input, and the user interface may be the display of the electronic device. For example, the user interface may be a capacitive sensing display which is configured to detect the shape and location of an object within its detection field.

The apparatus may be one or more of the display, the electronic device, a portable electronic device, a mobile phone, a smartphone, a tablet computer, a projector computer (such as a user interface projected onto a wall, board or tabletop, for example), a laptop computer, a personal digital assistant, a digital camera, a smartwatch, smart eyewear, a pen-based computer, a non-portable electronic device, a desktop computer, a display, a household appliance, a server, or a module for one or more of the same.

According to a further example, there is provided a computer program comprising computer program code, the computer program code being configured to perform at least the following: based on a detected sprinkle gesture user input, provide signalling to apply a visual effect to displayed content on a display of an electronic device.

According to a further example, there is provided a method comprising: based on a detected sprinkle gesture user input, providing signalling to apply a visual effect to displayed content on a display of an electronic device.

According to a further example there is provided an apparatus comprising: means for providing signalling to apply a visual effect to displayed content on a display of an electronic device based on a detected sprinkle gesture user input.

In a further example there is provided an apparatus comprising at least one processor and at least one memory including computer program code, the at least one memory and the computer program code configured to, with the at least one processor, cause the apparatus to perform at least the following: based on a detected sprinkle gesture user input, provide signalling to apply an output effect to be provided from a user interface of an electronic device. Thus, visual, sound and/or haptic output effects may be provided based on a detected sprinkle gesture.

According to a further example, there is provided an apparatus comprising means for signalling to apply an output effect to be provided from a user interface of an electronic device based on a detected sprinkle gesture user input.

The present disclosure includes one or more corresponding aspects, examples or features in isolation or in various combinations whether or not specifically stated (including claimed) in that combination or in isolation. Corresponding means and corresponding functional units (e.g. visual effect applicator, sprinkle gesture user input detector, gesture location detector) for performing one or more of the discussed functions are also within the present disclosure.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product. Corresponding computer programs for implementing one or more of the methods disclosed are also within the present disclosure and encompassed by one or more of the described examples.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus comprising a number of electronic components, including memory and a processor, according to one example of the present disclosure;

FIG. 2 illustrates an example apparatus comprising a number of electronic components, including memory, a processor and a communication unit, according to another example of the present disclosure;

FIG. 3 illustrates an example apparatus comprising a number of electronic components, including memory and a processor, according to another example of the present disclosure;

FIGS. 4a-4c illustrate example sprinkle gestures which may be detected according to examples of the present disclosure;

FIGS. 5a-5b illustrate examples of varying the visual effect applied based on varying the type of sprinkle gesture user input according to examples of the present disclosure;

FIGS. 6a-6d illustrate examples of how the applied visual effect may behave after application according to examples of the present disclosure;

FIGS. 7a-7d illustrate example applied visual effects according to examples of the present disclosure;

FIGS. 8a-8b illustrate an example of controlling an application using a sprinkle gesture user input according to examples of the present disclosure;

FIG. 9 illustrates schematically an example of a hover-sensitive detector suitable for detecting a sprinkle gesture user input according to examples of the present disclosure;

FIGS. 10a-10b illustrate examples of an apparatus in communication with a remote computing device according to examples of the present disclosure;

FIGS. 11a and 11b illustrate respective flowcharts according to example methods of the present disclosure; and

FIG. 12 illustrates schematically a computer readable medium providing a program.

### DESCRIPTION OF EXAMPLES

An electronic device may have a user interface which allows a user to interact with the device in different ways. For example, a device may comprise a touch-sensitive display which a user can touch to provide inputs to the device. Different user touches may provide different user inputs.

Certain electronic devices allow for a user to make a user input to a user interface without making contact with the device/user interface. Thus a user may be able to make a gesture at a distance away from the device/user interface, and the gesture may be detected and recognised as a user input.

Examples discussed herein may be considered to, based on a detected sprinkle gesture user input, provide signalling to apply a visual effect to displayed content on a display of an electronic device. More generally, other examples may be considered to, based on a detected sprinkle gesture user input, provide signalling to apply an output effect (e.g. sound/haptic/visual) to be provided from a user interface of an electronic device.

Accordingly, an apparatus may comprise or be in communication with an input device which can detect a user making a sprinkle gesture (for example, the user may rub a pinched thumb and index finger together as if sprinkling grains). A corresponding visual effect of sprinkled grains, for example, may be displayed on content shown on a display due to the detected sprinkle gesture. More generally, a convenient sprinkle gesture input can be used to provide, for example, a particular sound output or haptic output.

Thus advantageous use of allowing for a user to make a sprinkle gesture at a distance away from a device/user interface, such that the gesture is detected and provides a user input to a device which the user considers an intuitive way to interact with the device. A user may consider it advantageous to be able to make such a gesture which allows for a fun and creative way to interact with the device, and which mirrors real-world actions and effects.

The apparatus may be considered to use the detected shape and determine that, if a “sprinkling” shape is recognised, that a visual effect such as a granular visual effect should be applied to displayed content.

Advantageously, the user input (making a sprinkle gesture) and the effect of the detected gesture (applying an e.g. “sprinkled grains” visual effect) can mirror the user action and effect which would happen in the real world. For example in certain cases, if a user sprinkled grains of glitter onto a painting, the same gesture and same visual effect would be obtained as the user making a sprinkle gesture over a display screen displaying a digital image of a painting, and a glitter sprinkle visual effect being displayed on the painting.

Other examples depicted in the figures have been provided with reference numerals that correspond to similar features of earlier described examples. For example, feature number 100 can also correspond to numbers 200, 300 etc. These numbered features may appear in the figures but may not have been directly referred to within the description of these particular examples. These have still been provided in the figures to aid understanding of the further examples, particularly in relation to the features of similar earlier described examples. The initial discussion will be focussed with respect to visual effect to aid a focussed understanding of the present disclosure, and the more general output effects discussed later.

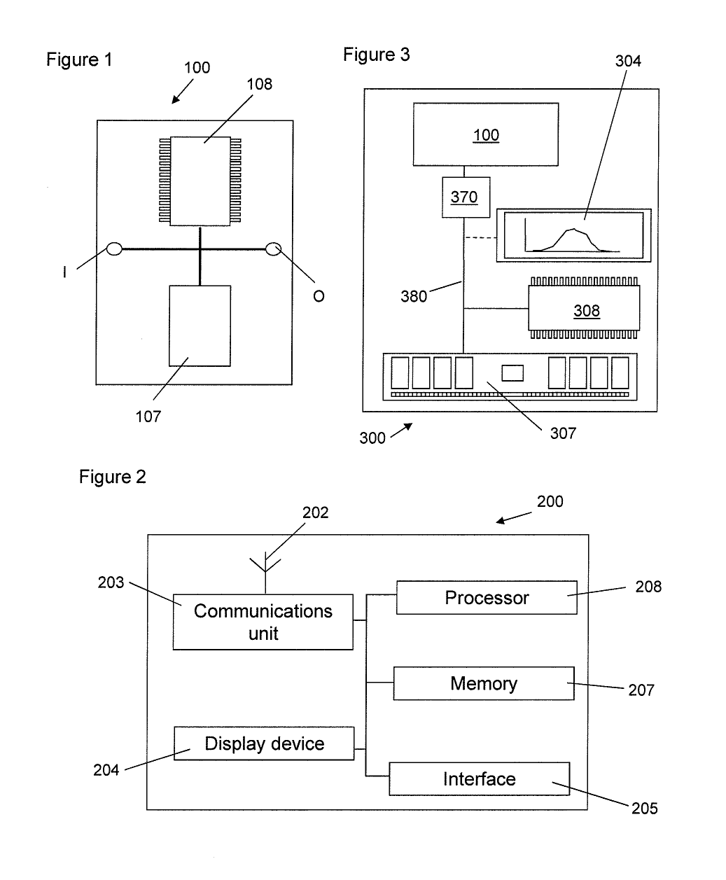

FIG. 1 shows an apparatus 100 comprising memory 107, a processor 108, input I and output O. In this example only one processor and one memory are shown but it will be appreciated that other examples may utilise more than one processor and/or more than one memory (e.g. same or different processor/memory types).

In this example the apparatus 100 is an Application Specific Integrated Circuit (ASIC) for a portable electronic device with a touch sensitive display. In other examples the apparatus 100 can be a module for such a device, or may be the device itself, wherein the processor 108 is a general purpose CPU of the device and the memory 107 is general purpose memory comprised by the device. The display, in other examples, may not be touch sensitive.

The input I allows for receipt of signalling to the apparatus 100 from further components, such as components of a portable electronic device (like a touch-sensitive or hover-sensitive display, or camera) or the like. The output O allows for onward provision of signalling from within the apparatus 100 to further components such as a display screen, speaker, or vibration module. In this example the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. ROM may be used to store computer code/instructions. RAM may be used for executing computer code/instructions. This computer program code stores instructions that are executable by the processor 108, when the program code is run on the processor 108. The internal connections between the memory 107 and the processor 108 can be understood to, in one or more examples, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 200 of a further example, such as a mobile phone. In other examples, the apparatus 200 may comprise a module for, for example, a mobile phone, and may just comprise a suitably configured memory 207 and processor 208.

The example of FIG. 2 comprises a display device 204 such as, for example, a liquid crystal display (LCD), e-Ink or touch/hover-screen user interface. The apparatus 200 of FIG. 2 is configured such that it may receive, include, and/or otherwise access data. For example, the apparatus 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. The apparatus 200 comprises a memory 207 that stores data, possibly after being received via antenna 202 or port or after being generated at the user interface 205. The processor 208 may receive data from the user interface 205, from the memory 207, or from the communication unit 203. It will be appreciated that, in certain examples, the display device 204 may incorporate the user interface 205. Regardless of the origin of the data, these data may be outputted to a user of apparatus 200 via the display device 204, and/or any other output devices provided with apparatus 200. The processor 208 may also store the data for later use in the memory 207. The memory 207 may store computer program code and/or applications which may be used to instruct/enable the processor 208 to perform functions (e.g. read, write, delete, edit or process data). The user interface 205 may provide for detection of the sprinkle gesture user input. This functionality may be integrated with the display device 204 in some examples.

FIG. 3 depicts a further example of an electronic device 300 comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device 307 may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory (RAM). The storage medium 307 may also be a permanent storage medium such as a hard disk drive, a flash memory, a remote server (such as cloud storage) or a non-volatile random access memory or read only memory (ROM). The storage medium 307 could be composed of different combinations of the same or different memory types.

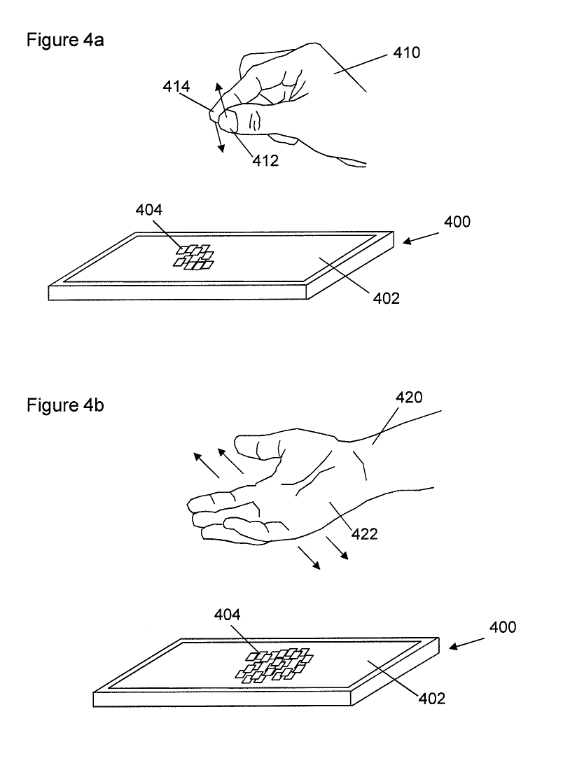

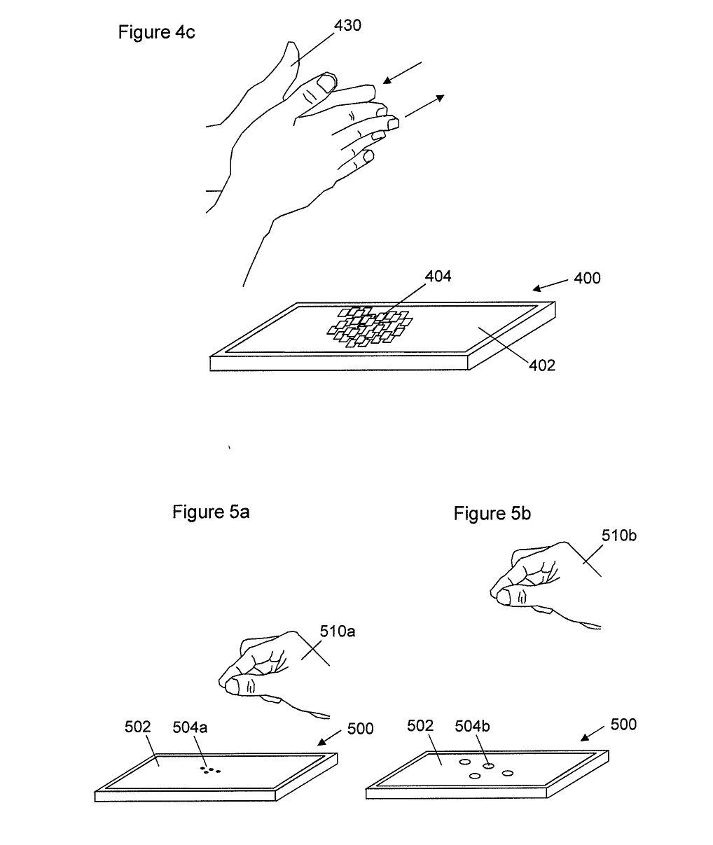

FIGS. 4a-4c illustrate examples of different sprinkle gestures 410, 420, 430 according to examples of the present disclosure. Such gestures 410, 420, 430 may be detected and, in response, an apparatus is configured to provide signalling to apply a visual effect to displayed content on a display 402 of an electronic device 400. In these examples, the apparatus configured to provide signalling to apply the visual effect may be the electronic apparatus/device 400, a module or component for the apparatus/device 400, or a remote server in communication with the apparatus/device 400. The apparatus comprises a processor; and a memory including computer program code, for example as discussed in relation to FIGS. 1-3.

The apparatus/device 400 comprises a display 402 and may be, for example, the display, the electronic device, a portable electronic device, a mobile phone, a smartphone, a tablet computer, a projector computer, a laptop computer, a personal digital assistant, a digital camera, a smartwatch, smart glasses/eyewear, a pen-based computer, a non-portable electronic device, a desktop computer, a monitor/display, or a household appliance

In FIGS. 4a-4c, the sprinkle gesture user input 410, 420, 430 is substantially above the user interface 402 which is configured to detect the sprinkle gesture input. In this example the user interface 402 is the display of the apparatus/device 400 which comprises a proximity detector able to detect a sprinkle gesture within its detection field. In other examples the user interface which is configured to detect the sprinkle gesture input may comprise a one or more of camera (such as a visual light camera or an infra-red camera), an ultrasonic sensor, a heat sensor, a microphone, or other detection apparatus which can detect a sprinkle user gesture. For example, a camera may be used to visually detect a user's hand in a sprinkle gesture shape, while a microphone may detect the sound of the user rubbing fingers together in the sprinkle gesture.

In FIGS. 4a-4c, the relative spatial location of the applied visual effect 404 is substantially aligned with the relative spatial location of the detected sprinkle gesture 410, 420, 430 on the display 402. That is, the user makes a sprinkle gesture user input 410, 420, 430 over the display 402 and the position of the displayed visual effect 404 is directly below the detected location of the sprinkle gesture user input 410, 420, 430. Applying the visual effect underneath the detected location of the sprinkle gesture user inputs can advantageously provide an intuitive user experience, because if, in the real world, a user sprinkled grains onto a table, the grains would land underneath the user's fingers.

FIG. 4a illustrates a single-handed sprinkle gesture user input 410. The sprinkle gesture user input 410 is a single-handed gesture input comprising rubbing together of the thumb of the hand 412 with one or more other digits of the hand (in this example, the thumb 412 is rubbing together with the index finger 414). This sprinkle user gesture may be considered a similar action to the gesture used to pick up a pinch of salt for sprinkling over food, or pinching some glitter to sprinkle over a drawing.

In other examples the user may rub the thumb together with the middle finger, the thumb together with the index and middle fingers, or the thumb together with one or more other finger combinations. All these sprinkle gestures may be detected and determined to be sprinkle gesture user inputs for the application of a visual effect to displayed content.

A hand usually comprises five digits. A thumb, an index finger, a middle finger, a ring finger and a little finger. The index finger is finger next to thumb. The middle finger is next to the index finger. The ring finger is next to the middle finger. The little finger is next to the ring finger.

It may be that rubbing sprinkle gesture user inputs using different thumb/finger combinations are detected as different inputs, and each may provide a different user input. For example, using more fingers in the rubbing gesture may apply a visual effect more quickly than if a single finger and thumb is used. As another example, rubbing a thumb and index finger may provide a sprinkled glitter visual effect, rubbing a thumb and middle finger may provide a highlight visual effect, and rubbing a thumb with both the index and middle fingers may provide an ink droplet visual effect.

The rubbing may be repeated rubbing back and forth of the thumb 412 and finger(s) in some examples. In other examples, the rubbing may be a single rubbing sprinkle gesture where the thumb and finger(s) pass over each other in contact just once. One or more of these types of rubbing may be detected and determined to be sprinkle gesture user inputs. It may be that a single detected rubbing sprinkle gesture provides a different user input to a continuous detected rubbing sprinkle user gesture.

The rubbing may be periodically repeated (for example, short bursts of rubbing separated by pauses where the user's fingers and thumb are detected by the user interface but are not moving/rubbing together) or continuous. The rubbing may be repeated in the same direction (for example the user may touch his thumb and finger(s) together then move his thumb to the right together with his finger(s) to the left, before separating his thumb and fingers(s) and repeating the same rubbing gesture) in some examples. The rubbing may be back-and-forth rubbing without breaking thumb/finger contact in some examples.

FIG. 4b illustrates a single-handed sprinkle gesture user input 420. In this example the user's hand 422 is held in a substantially flat open position (the fingers may or may not be held together) and is shaking back and forth over the display 402 of the apparatus/device 400. In other examples the user's hand may be held in a partially closed cupped “C” configuration. Upon detection of the user's hand shaking back and forth, the apparatus can apply a visual effect to displayed content. This sprinkle user gesture may be considered a similar action to the gesture used to sprinkle a handful of seeds or grains on the ground, for example.

FIG. 4c illustrates a two-handed sprinkle gesture user input 430. The user in this example is rubbing together his palms to make the sprinkle gesture. In other examples, the user may rub together his fingers from respective hands, or may rub together both his palms and fingers, or palms with opposing fingers. This sprinkle user gesture may be considered a similar action to the gesture used to rub particles of dust or soil from hands after cleaning/gardening, for example.

FIGS. 5a-5b illustrate examples of a sprinkle gesture 510a, 510b made at different distances from the display 502 of an apparatus/device 500 according to examples of the present disclosure. The sprinkle gesture 510a, 510b is detected and, in response, an apparatus is configured to (provide a signal to) apply a visual effect to displayed content on the display 502.

The apparatus configured to provide a signal to apply the effect may be the apparatus/device 500, a module or component for the apparatus/device 500, or a server in communication with the apparatus/device 500, as discussed above. In FIGS. 5a-5b the user interface configured to detect the sprinkle gesture user input 510a, 510b is a proximity sensing display 502, but in other examples may be another detector/user interface as discussed above. The proximity sensing display 502 is able to detect the shape of an object, such as a human hand, within its field of view, as well as determining the distance of the hand from the display 502.

In these examples, the separation of the sprinkle gesture user input 510a, 510b to the proximity sensing display 502 is detected and used to change the way in which the visual effect 504a, 504b is displayed on the display 502 of the apparatus/device 500.

In FIG. 5a, the sprinkle gesture user input 510a is made relatively close to the proximity sensing display 502. The displayed visual effect applied is a series of relative small, relatively closely spaced grains.

In FIG. 5b, the sprinkle gesture user input 510a is made relatively far away from the proximity sensing display 502. The displayed visual effect applied is a series of relatively large grains which are well spaced over the display 502.

Therefore in these examples, increasing the separation of the sprinkle gesture user input 510a, 510b from the proximity sensing display 502 increases the size of the grains applied as a visual effect, and increases the separation of the grains applied as a visual effect. In some examples only the grain size, or only the grain separation, may change depending on the separation of the sprinkle gesture user input 510a, 510b to the proximity sensing display 502. Rather than increasing separation providing increasing grain size and/or grain separation, decreasing grain size and/or grain separation may be provided in some examples.

In some examples, the visual effect may be accompanied by a further output. For example, as the granular visual effect is applied an audio output may be provided, such as the sound of sand grains falling onto a hard surface. Increasing the separation of the sprinkle gesture user input 510a, 510b from the proximity sensing display 502 may increase (or decrease) the volume of an accompanying audio output. This may advantageously enhance the user experience by providing a more realistic simulation of sprinkling grains.

In some examples, other visual effects may be provided to provide a more real-world feel for the user. For example, the user may make a sprinkle gesture user input below a predetermined height from the display screen, and the visual effect may be of grains appearing on the screen. If the user makes the same gesture but above the predetermined height, the visual effect may be grains appearing, and then bouncing or scattering before resting in a particular location on the screen. This effect may be considered to mimic the effect of falling grains in the real world which, if dropped from a sufficient height, may bounce and scatter before stopping. As another example, if the visual effect applied due to the sprinkle gesture user input is of paint or ink droplets, then if the sprinkle gesture user input is made above a predetermined height from the display screen, the virtual sprinkled paint/ink drops may be displayed in a “splat” shape to mimic the shape of a real world liquid droplet falling from a sufficient height. By detecting and using the parameter of the height of the sprinkle gesture user input from the display screen, the apparatus may provide an enhanced visual effect for the user which more closely mirrors real world effects.

In other examples the visual effect may vary depending on the separation of the sprinkle gesture user input to the display even if it is not the display which is detecting the user input. For example, a camera mounted away from the line between the user's hand and the display screen may be able to detect the presence of the user's hand making a sprinkle gesture user input, and the distance between the user's hand and the display may be determined (for example, by the camera, the apparatus applying the visual effect, or another apparatus/processor).

In some examples, the speed of the sprinkle gesture user input may be detected and used to increase the speed of application of the visual effect to displayed content based on an increased speed of the detected sprinkle gesture. Examples of changing the gesture speed include rubbing the fingers/hands together more quickly or more slowly, or shaking an open hand more quickly or slowly, to correspondingly apply the visual effect more quickly or more slowly.

Another example of changing the gesture speed is to move from using a pinch sprinkle gesture user input such as that shown in FIG. 4a, to using a scattering sprinkle gesture user input such as that shown in FIG. 4b. In the real world, sprinkling grains using a pinch gesture may be considered to provide slower sprinkling that scattering grains from a (partially) open hand. Therefore detection of a pinch sprinkle gesture user input may allow for slower application of a visual effect than detection of a scattering sprinkle gesture user input.

The visual effect applied due to detection of the sprinkle gesture user input may provide for incremental application of the visual effect according to the duration of the sprinkle gesture input. Thus as the duration of the sprinkle gesture user input increases, the visual effect applied to displayed content due to the detected sprinkle gesture user input also increases. The application may be considered to be incremental as an increasing number of discrete individual “grains” are applied to the displayed content in a “granular” manner, to give the visual effect of sprinkled grains/particles. More “grains” are added to the displayed content as the detected sprinkle gesture user input continues. A “granular” visual effect may be considered to include visual effects mimicking sand, salt, spheres or glitter grains, lighter, glowing, reflective, shiny or highlight spots, or ink or paint drops, for example.

The granular visual effect may be applied on a particular spatial region of the displayed content corresponding to the relative spatial location of detected sprinkle gesture. For example, if the user makes a sprinkle gesture user input directly above a particular region of displayed content, the resulting granular visual effect may be applied in that particular region but not in other regions.

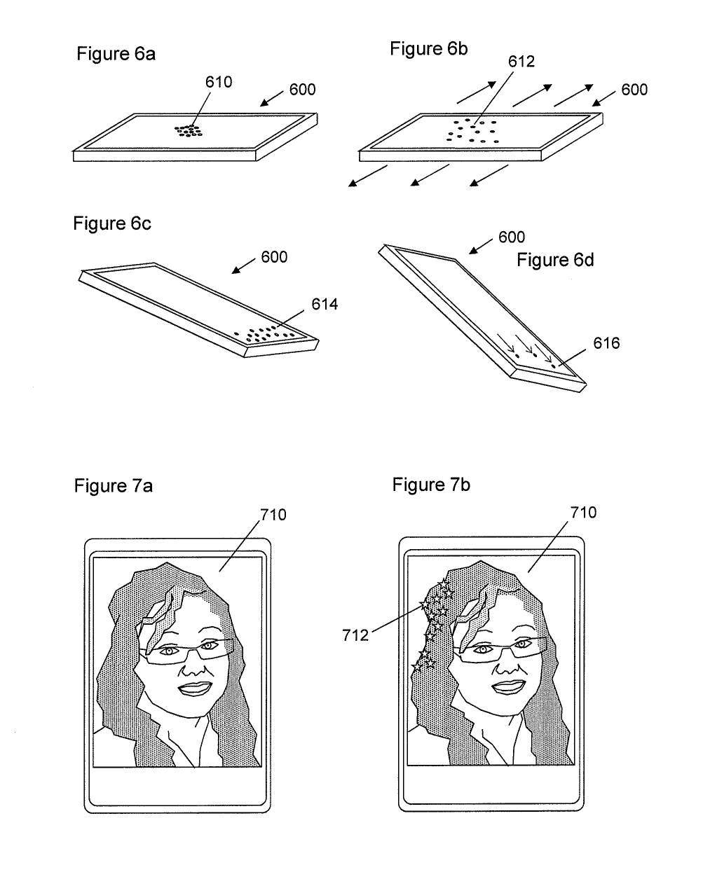

The displayed visual effect applied based on a detected sprinkle gesture user input may be displayed in such a way that it can behave as a separate “granular” layer overlaying the displayed content. FIGS. 6a-6d illustrate how the visual effect may behave according to examples of the present disclosure. In FIG. 6a, a granular visual effect 610 has been applied to content displayed on the display of an apparatus/device 600 due to a detected sprinkle gesture user input. In FIG. 6b the user has shaken the apparatus/device 600 horizontally, which has been detected and upon detection, the granular visual effect 612 has changed to show the “grains” of the visual effect with an increased spacing compared to their displayed locations prior to the shaking.

In FIG. 6c, the user has tilted the apparatus/device 600 and the “grains” of the visual effect 614 have changed position again to appear to slide down the display. This may occur until a critical tilt angle threshold is reached, for example, 45° . In FIG. 6d, the user has tilted the apparatus/device 600 further. The visual effect 616 appears to “slide down” the display screen to give the effect that the display screen is tilted at too steep a gradient for the applied “grain” effect to stay on the displayed content. The “grains” 616 may appear to “slide off” the tilted display screen and be removed from display. In other example, the “grains” may remain displayed along a lower edge of the display screen, and may, for example, be re-distributed over the displayed content by tilting the apparatus/device 600 towards (and beyond) horizontal again.

Such effects may give the impression of the applied granular visual effect simulating separate grains resting on the surface of the displayed content, for example. In relation to FIGS. 6c and 6d, the apparatus is configured to progressively remove the applied visual effect after a predefined tilt threshold of the user interface used to detect the sprinkle gesture input is achieved. These effects may provide an enhanced user experience by simulating real world actions.

In some examples, the user may be able to change the region of the displayed content over which a visual effect is applied by changing the tilt angle of the display. For example, making a sprinkle gesture user input at one location over a horizontal display may result in application of a visual effect within an approximately circular area underneath the user's hand(s). If the display is tilted, for example to 10-15° away from horizontal (as detected by a gyroscope coupled to the display, for example), then making a sprinkle gesture user input at one location over the tilted display may result in application of a visual effect within an approximately oval area underneath the user's hand(s) due to the tilt of the display. Increasing the tilt angle may result in an increase in the size of the oval area to which the visual effect is applied. Thus the apparatus may be configured to apply the visual effect more widely across the displayed content according to the direction of the tilt of the user interface used to detect the sprinkle gesture input.

As described above in relation to tiling a device which is already displaying a visual effect applied due to detection of a sprinkle gesture user input, a user may tilt the apparatus/device 600 prior to making the sprinkle gesture user input. If the apparatus/device 600 is at too steep an angle (i.e., beyond a predetermined tilt threshold) a visual effect may not be applied upon detecting a sprinkle gesture user input, or the effect may be applied only to appear to slide off the display screen.

In some examples a user may be able to preferentially preselect or mark one or more regions on displayed content where he wishes the visual effect to be applied. Upon making the sprinkle gesture user input, a visual effect may be applied in those preselected/preferential areas but not to other areas. This may be considered to mimic, for example, a user spreading glue onto regions of a picture before sprinkling glitter onto the picture. The glitter sticks to the glue but not to the non-glued areas. A visual effect may be provided in relation to virtual sprinkled grains which are not applied over a preselected “glue” area. For example, the virtual grains may be moved onto the preselected “glue” areas and/or off the display screen by shaking or tilting the device after application of the virtual grains (similar to shaking a picture with glitter/grains sprinkled over it), the virtual grains may be attracted to the preselected “glue” areas (similar to iron filings being attracted to a magnetic region), or the virtual grains may only appear on the preselected “glue” areas and not elsewhere on the displayed content.

Granular effects encompass particulate, droplet, and discrete visual effects. In the case of droplet effects, these may be likened to the application of, for example, spreadable or non-spreadable paint or ink droplets. Spreadable droplets may be spread by tilting the user interface used to detect the sprinkle gesture user input as otherwise described herein, for example.

In other examples the applied visual effect may not necessarily be granular or of a series of discrete marks. The visual effect may be, for example, a uniform visual effect. For example, a continuous colour or effect may be applied to the displayed content, such as applying a colour filter (e.g. blue tint, sepia tit, fading a colour image to black and white), applying an artistic effect or applying a block of colour, for example. Providing the sprinkle gesture user input for a prolonged duration may result in, for example, a stronger uniform colour or effect being applied in a particular region as the duration of the gesture increases (e.g. within a circle area of the displayed content), or a uniform effect being applied over a gradually expanding area during detection of the sprinkle gesture user input.

In some examples the user may be able to set the properties of the applied visual effect. For example, the user may be able to set a preference for a uniform or a granular visual effect to be applied. For a granular effect, the user may be able to set a preference for easily displaced “grains”, for example grains acting a spheres, for more difficult to displace “grains”, for example grains acting a rough particles such as sand or glitter, and for other displaceable “grains” for example those acting spreadable ink drops.

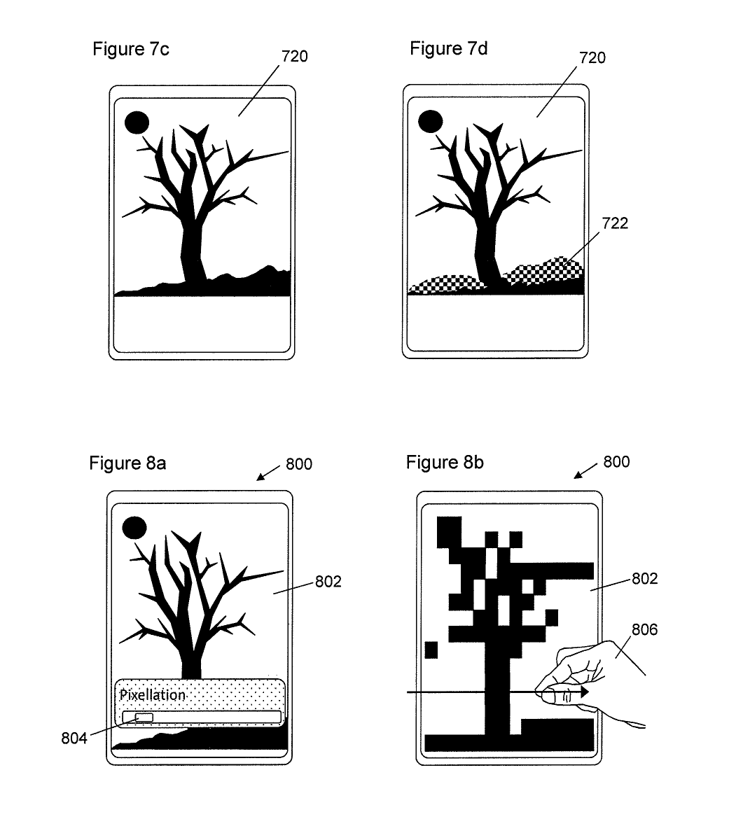

FIGS. 7a-7b illustrate an example of a visual effect applied to displayed content due to detection of a sprinkle gesture user input according to examples of the present disclosure. In FIG. 7a the user is displaying a photograph of a friend 710. The user then applies a visual effect by making a sprinkle user gesture over a portion of the displayed content corresponding to a part of the user's hair in the photograph. In FIG. 7b, the displayed visual effect 712 is of glitter on the user's hair, applied due to the user's sprinkle gesture user input over the hair region of the displayed image.

FIGS. 7c-7d illustrate another example of a visual effect applied to displayed content due to detection of a sprinkle gesture user input according to examples of the present disclosure. In FIG. 7c the user is displaying a photograph of a landscape 720. The user then applies a visual effect by making a sprinkle user gesture over a portion of the displayed content corresponding to the ground in the photograph. In FIG. 7d, the displayed visual effect 722 is of snow on the ground, applied due to the user's sprinkle gesture user input over the ground region of the image.

A visual effect may not necessarily be a particulate effect. For example, the visual effect applied may be: a uniform change of colour, hue or colour scheme (e.g, gradually changing colour to black-and-white, or the non-gradual but discrete application of a colour filter), and application of a visual highlight (e.g. a light, border or visual enhancement effect). Thus sharply/discretely applied visual effects as well as gradual application of visual effects are encompassed. The application of a glowing, glistening, reflective, or shiny granular effect (e.g. to give the impression of glitter, liquid droplets, sand, or metal flakes, for example) can be considered to be discrete particulate effects.

In the examples of FIGS. 7a-7d, the user's sprinkle gesture user input may have been pre-defined to provide a “glitter” or a “snowflake/white grain” effect. This may be done, for example, by selecting a “glitter” or “white grain” option from an artistic menu, or by making a particular type of sprinkle gesture user input pre-associated with applying a particular effect (e.g. rubbing two palms together is detected as a gesture to apply a glitter effect, but rubbing a thumb and index finger is detected as a gesture to apply a white grain effect). Thus the user may apply artistic visual effects to displayed content such as photographs in an intuitive and creative way.

The display on which the visual effect is applied need not necessarily be vertically below the sprinkle gesture and could be in the same horizontal plane. For example, the displays shown in FIGS. 7a-7d may be wall mounted apparatus/devise such as Smart TVs, and the user may make a sprinkle gesture user input in the air in front of the TV screen (or a camera mounted with the TV screen).

FIGS. 8a-8b illustrate an example of controlling an application using a detected sprinkle gesture user input according to examples of the present disclosure. In FIG. 8a the apparatus/device 800 is displaying an image 802 of a tree using an image editing application in this example. The user is able to change parameters within the application to change the visual effects applied to the image 802. FIG. 8a shows a slider 804 which the user may touch and move from left to right to increase or decrease the pixellation effect applied to the image 802. Moving the slider 804 to the right of the slider bar increases the level of pixellation on the displayed image 802, while moving the slider 804 to the left of the slider bar decreases the level of pixellation on the displayed image 802.

FIG. 8b shows that the user can also use a sprinkle gesture user input 806 to control the application. A user may make a sprinkle gesture user input 806 and move the gesturing hand 806 from left to right over the display screen of the apparatus/device 800 to control the degree of pixellation, in the same way that the slider 804 in FIG. 8a may be used. Moving the sprinkle gesture user input 806 to the right of the apparatus/device 800 increases the level of pixellation on the displayed image 802, while moving the sprinkle gesture user input 806 to the left of the apparatus/device 800 decreases the level of pixellation on the displayed image 802. While the user is interacting with the application using the sprinkle gesture user input 806, in this example, the slider bar is removed form display (that is, the slider 804 is temporarily dismissed from view). This may advantageously help the user to see the effect being applied over the whole unobscured image 802.

Of course, while changing the degree of pixellation has been illustrated in FIGS. 8a-8b, other types of visual effect may be controlled in the same way. For example, moving a sprinkle gesture user input over a displayed image/displayed content may cause a variation in: colour intensity; brightness; contrast; application of a colour tone such as sepia, black and white, or a colour filter; image sharpening/blurring; or another artistic effect.

In another example embodiment the sprinkle gesture user input may be performed in a camera application. For example, the user may apply effects to the camera viewfinder's image even before an image has been taken with the camera. For example, moving a sprinkle gesture user input over a displayed viewfinder image/displayed content may cause a variation in: colour intensity; brightness; contrast; application of a colour tone such as sepia, black and white, or a colour filter; image sharpening/blurring; or another artistic effect.

In another example embodiment the whole user interface theme may be changed with the sprinkle gesture. At least one user interface object, such as an icon, a text, etc., may be changed according to the performed sprinkle gesture. For example, moving a sprinkle gesture user input over a displayed user interface content may cause a variation in: colour intensity; brightness; contrast; application of a colour tone such as sepia, black and white, or a colour filter; image sharpening/blurring; or another artistic effect.

It will be appreciated that the above mentioned visual effects can be considered in the context of still images (e.g. taken using a particular still picture camera) or one or more respective picture stills of a sequence of pictures forming a video image (e.g. taken using a video camera).

Taking the more general case of modifying output from a user interface of an electronic device, in another example embodiment, other aspects of the content may be modified based on the sprinkle gesture user input. For example, in a video or audio playback the tone or pitch of the audio may be changed based at least on part on the sprinkle gesture user input. The more grains are applied to the content the more bass-tone may be applied to the audio, for example. Similarly tactile, or haptic, feedback effects may be modified with the sprinkle user input gesture. For example, in the case more profound vibration, or tactile feedback is requested by the user, the user may perform the sprinkle user gesture input to change the vibration, or tactile feedback, settings. As a further example, the more the user rubs his hands together, or more grains applied on the device, the more intense tactile feedback setting may be set.

The apparatus may in some examples be configured to detect the sprinkle gesture input itself. For example, if the apparatus comprises a detector such as a proximity sensor or a camera this may be used to detect the sprinkle gesture user input. The apparatus may in some examples be configured to receive an indication of the detected sprinkle gesture input from another apparatus which detected the sprinkle gesture input. For example, the apparatus may receive an indication that a sprinkle gesture user input has been detected by a peripheral detector and the apparatus uses that indication to provide signalling to apply a visual effect to displayed content (or other output effect using a user interface of the electronic device). In some examples the user interface configured to detect the sprinkle gesture input may be the display of the electronic device, for example a proximity sensing display device such as a capacitive sensor display.

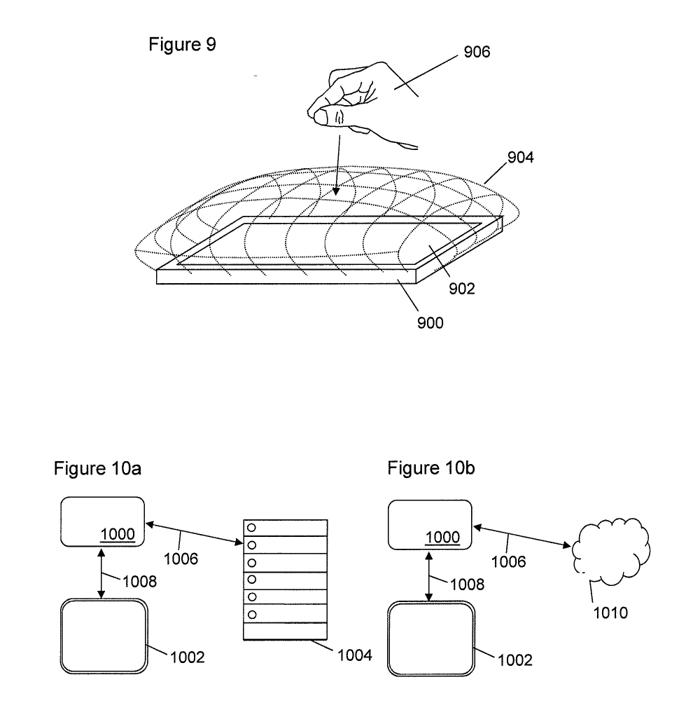

FIG. 9 illustrates detection of a hovering sprinkle gesture user input according to examples of the present disclosure. The display screen 902 of an apparatus/device 900 may be (or be overlaid by) a 3-D hover-sensitive layer such as a capacitive sensing layer. Such a layer may be able to generate a virtual detection mesh 904 in the area surrounding the display screen 902 up to a distance from the screen 902 of, for example 3 cm, 5 cm, 7 cm, or 10 cm or more, depending on the particular layer used. The virtual mesh 904 may be generated as a capacitive field.

The 3-D hover-sensitive layer may be able to detect hovering objects 906, such as a finger, hand, or hands, within the virtual mesh 904. In some examples the layer may also be configured to detect touch inputs (wherein the user's finger or pen, for example, make physical contact with the layer). The virtual mesh 904 may extend past the edges of the display screen 902 in the plane of the display screen 902. The virtual mesh 904 may be able to determine the shape, location, movements and speed of movement of the object 906 based on objects detected within the virtual mesh 904. Thus, for example, the virtual mesh 904 may be able to discriminate between different types of sprinkle gesture user input as described herein, and may be able to determine the position and location of the user's hand(s) relative to the display screen 902.

FIG. 10a shows an example of an apparatus 1000 in communication 1006 with a remote server. FIG. 10b shows an example of an apparatus 1000 in communication 1006 with a “cloud” for cloud computing. In FIGS. 10a and 10b, apparatus 1000 (which may be apparatus 100, 200 or 300) is also in communication 1008 with a further apparatus 1002. The further apparatus 1002 may be a hover sensitive display or a camera for example. In other examples, the apparatus 1000 and further apparatus 1002 may both be comprised within a device such as a portable communications device or PDA. Communication 1006, 1008 may be via a communications unit, for example.

FIG. 10a shows the remote computing element to be a remote server 1004, with which the apparatus 1000 may be in wired or wireless communication 1006 (e.g. via the internet, Bluetooth, NFC, a USB connection, or any other suitable connection as known to one skilled in the art). In FIG. 10b, the apparatus 1000 is in communication 1006 with a remote cloud 1010 (which may, for example, be the Internet, or a system of remote computers configured for cloud computing).

For example, the further apparatus 1002 may be a 3-D hover sensitive display and may detect distortions in its surrounding field caused by a proximal object, such as a user's hand making a sprinkle gesture. The measurements may be transmitted via the apparatus 1000 to a remote server 1004 for processing and the processed results, indicating an on-screen position of the hovering object, may be transmitted to the apparatus 1000 for use in applying a visual effect. As another example, the further apparatus 1002 may be a camera and may capture images of a user's hand and finger positions in front of the camera. The images may be transmitted via the apparatus 1000 to a cloud 1010 for (e.g. temporary) recordal and processing. The processed results, indicating, for example, user hand position, speed of finger motion in a rubbing movement, and/or movement of the user's hand over the surface of the display, may be transmitted back to the apparatus 1000. In other examples the further apparatus 1002 may also be in direct communication with the remote server 1004 or cloud 1010.

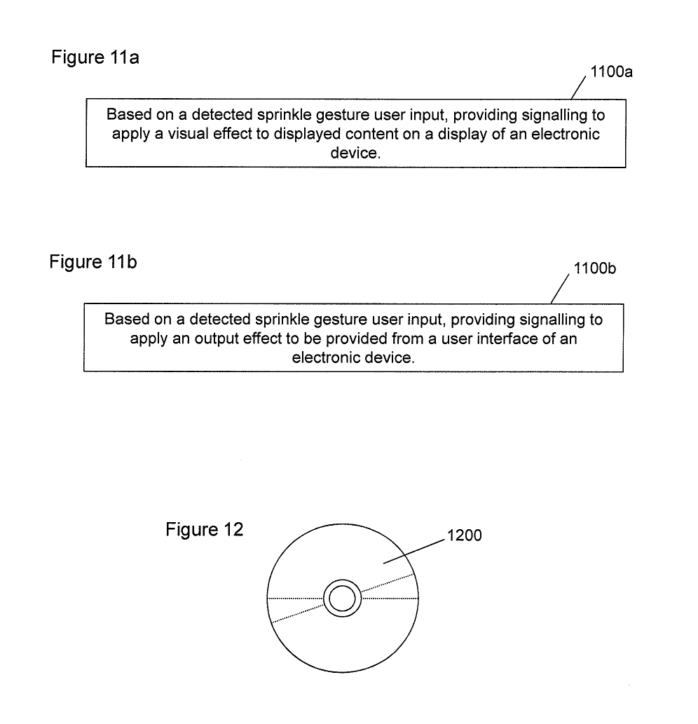

FIG. 11a illustrates a method 1100a according to an example of the present disclosure. The method 1100 comprises, based on a detected sprinkle gesture user input, providing signalling to apply a visual effect to displayed content on a display of an electronic device. In some examples the method may further comprise detecting the sprinkle gesture user input. FIG. 11b illustrates a method according to an example of the present disclosure. The method 1100b comprises, based on a detected sprinkle gesture user input, provide signalling to apply an output effect to be provided from a user interface of an electronic device.

FIG. 12 illustrates schematically a computer/processor readable medium 1200 providing a program according to an example, for example, applying a visual effect to displayed content on a display of an electronic device based on a detected sprinkle gesture user input. In this example, the computer/processor readable medium is a disc such as a Digital Versatile Disc (DVD) or a compact disc (CD). In other examples, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
a processor; and
a memory including computer program code,
the memory and the computer program code configured, with the processor, to cause the apparatus to perform at least the following:
based on a detected sprinkle gesture user input, provide signalling to apply an output effect using a user interface of an electronic device.

2. The apparatus of claim 1, wherein the output effect is one or more of a visual effect, a sound effect and a haptic effect.

3. The apparatus of claim 1, wherein the sprinkle gesture user input is one of a single-handed gesture input and a two-handed gesture input.

4. The apparatus of claim 1, wherein the sprinkle gesture user input is one of a single-handed gesture input and a two-handed gesture input substantially above a user interface configured to detect the sprinkle gesture input and the relative spatial location of an applied visual effect is substantially aligned with the relative spatial location of the detected sprinkle gesture on the user interface.

5. The apparatus of claim 1, wherein the sprinkle gesture user input is a single-handed gesture input comprising one or more of:
rubbing together of the thumb of the hand with one or more other digits of the hand;
rubbing together of the thumb of the hand with one or more other digits of the hand substantially above a user interface configured to detect the sprinkle gesture input;
rubbing together of the thumb of the hand with one or more other digits of the hand substantially above a user interface configured to detect the sprinkle gesture input and the relative spatial location of an applied visual effect is substantially aligned with the relative spatial location of the detected sprinkle gesture on the user interface; and
shaking of one or more of: a substantially flat open hand; and a partially closed cupped hand.

6. The apparatus of claim 1, wherein the sprinkle gesture user input is a two-handed gesture input comprising one or more of:
rubbing together of one or more of the digits and palms from the respective two hands;
rubbing together of one or more of the digits and palms from the respective two hands substantially above a user interface configured to detect the sprinkle gesture input; and
rubbing together of one or more of the digits and palms from the respective two hands substantially above a user interface configured to detect the sprinkle gesture input and the relative spatial location of an applied visual effect is substantially aligned with the relative spatial location of the detected sprinkle gesture on the user interface.

7. The apparatus of claim 2, wherein the apparatus is configured to increase the speed of application of the visual effect based on an increased speed of the detected sprinkle gesture.

8. The apparatus of claim 2, wherein the apparatus is configured to apply a differential visual effect according to the detected sprinkle gesture.

9. The apparatus of claim 2, wherein the apparatus is configured to apply the visual effect incrementally according to the duration of the sprinkle gesture input.

10. The apparatus of claim 2, wherein the visual effect is a granular application of the visual effect on a particular spatial region of the displayed content corresponding to the relative spatial location of detected sprinkle gesture.

11. The apparatus of claim 2, wherein the visual effect is a granular application of the visual effect and the apparatus is configured to, as the separation between the detected user input and a user interface configured to detect the user input increases, one or more of:
the separation of grains in the visual effect increases or decreases;
the size of grains in the visual effect increases or decreases;
an audio signal accompanying the application of the granular application of the visual effect increases or decreases in volume.

12. The apparatus of claim 2, wherein the apparatus is configured to, based on a particular distance separation from a user interface configured to detect the sprinkle gesture user input, apply one or more of a bounce and scatter visual effect, and a splat visual effect.

13. The apparatus of claim 2, wherein the apparatus is configured to provide signalling to apply the visual effect preferentially to particular marked regions of the displayed content.

14. The apparatus of claim 2, wherein the visual effect is one or more of: a change of colour, application of a visual highlight, and application of a glowing, glistening, reflective, or shiny granular effect.

15. The apparatus of claim 2, wherein the apparatus is configured to apply the visual effect over an increasing area across the displayed content according to one or more of the direction of, and an increasing degree of tilt of, one or more of:
a user interface used to detect the sprinkle gesture input, and
the display of the electronic device which is displaying content.

16. The apparatus of claim 2, wherein the apparatus is configured to one or more of remove, and progressively remove, the applied visual effect after a predefined tilt threshold of a user interface used to detect the sprinkle gesture input is achieved.

17. The apparatus of claim 1, wherein the apparatus is configured to one or more of:
detect the sprinkle gesture input itself, and
receive an indication of the detected sprinkle gesture input from another apparatus which detected the sprinkle gesture input.

18. The apparatus of claim 1, wherein the apparatus is one or more of: the display, the electronic device, a portable electronic device, a mobile phone, a smartphone, a tablet computer, a projector computer, a laptop computer, a personal digital assistant, a digital camera, a smartwatch, smart eyewear, a pen-based computer, a non-portable electronic device, a desktop computer, a display, a household appliance, a server, or a module for one or more of the same.

19. A computer readable medium comprising computer program code stored thereon, the computer readable medium and computer program code being configured to, when run on at least one processor perform at least the following:
based on a detected sprinkle gesture user input, provide signalling to apply an output effect using a user interface of an electronic device.

20. A method comprising:
based on a detected sprinkle gesture user input, providing signalling to apply an output effect using a user interface of an electronic device.
